(19) United States
(12) Patent Application Publication
(10) Pub. No.: US 2026/0069906 A1
(43) Pub. Date: Mar. 12, 2026

(54) FIREPROOF ELECTRICAL JUNCTION BOX (EMBODIMENTS)

(71) Applicant: Yuriy Aleksandrovich GABLIYA, g. Mocow (RU)

(72) Inventor: Evgenii Sergeevich KAPLUN, s. Malaya Tsarevshchina (RU)

(21) Appl. No.: 19/117,825

(22) PCT Filed: May 30, 2024
(86) PCT No.: PCT/RU2024/000173

§ 371 Date: Apr. 2, 2025

(30) Foreign Application Priority Data
Jun. 19, 2023 (RU) 2023115992

(51) Int. Cl. A62C 35/00; A62C 3/16; A62D 1/00

(52) U.S. Cl. CPC A62C 35/00; A62C 3/16; A62D 1/00

(57) ABSTRACT

The invention relates to electrical equipment, and more particularly to electrical junction boxes having in the structure thereof a fire extinguishant for preventing combustion. The technical problem addressed by the claimed solutions is that of broadening the functional capabilities of electrical junction boxes. The technical result of the claimed invention consists in making it possible to completely suppress combustion inside an electrical junction box without the use of external fire-extinguishing means. This technical result is achieved in a fireproof electrical junction box comprising a polymer housing with inner projections that form a cavity for holding a fire extinguishant designed to be capable of exiting into the space of the housing to be protected, said fire extinguishant consisting of an aerosol-forming composition (AFC) or a mixture of an AFC and a microencapsulated agent. The technical result is also achieved in a fireproof electrical junction box comprising a polymer housing with a thermal cord disposed therein that is filled with a fire extinguishant designed to be capable of exiting into the space of the housing to be protected, said fire extinguishant consisting of an aerosol-forming composition (AFC) or a mixture of an AFC and a microencapsulated agent.

### FIELD OF TECHNOLOGY

The invention relates to electrical devices, namely Electric Junction Boxes having in their structure a Fire Extinguishing Agent (FEA) for preventing fires.

When operating electrical equipment, fires are not uncommon, the causes of which may be as follows: overloading of electrical installations and wiring; short circuits; ignition of combustible materials; excessive transient resistance in the contact groups of electrical wiring.

It is necessary to suppress such fires in a timely manner, without human participation, thus eliminating the possibility of electric shock, saving human lives and expensive equipment, protecting buildings and structures from the spread of fires.

### STATE-OF-ART

The following fire extinguishing means are known from the prior art for suppressing fire in electrical installations.

Autonomous gas fire extinguishing unit (Patent RU 139678), which in its composition contains a cylinder with a gas extinguishing agent (e.g., Freon) connected to a line for supplying the extinguishing medium to the protected volume, made of fusible polymeric material. The line is connected to the cylinder by means of a shut-off and launching device with a pressure gauge and a ball valve, and is provided with an elastic outer shell in the form of a metal spiral. This fire extinguishing system is characterized by a multi-component and highly labor-intensive installation in the protected volume.

A means of fixing the fire extinguishing cord in the electric cabinet is known (Patent RU 190409). Fire extinguishing cord, or pyrocord, is a self-contained fire extinguishing unit with thermally activated microencapsulated extinguishing agent intended for protection against fires in large-sized fire-hazardous objects containing electrical equipment, such as switchboards, control cabinets, electric cabinets, safes, etc. The technical solution according to this patent is a device holding a fire extinguishing cord in an electrical enclosure, having a support for attachment to the inner walls of the electrical enclosure and made in the form of a bendable fastener with a groove for the cord, and with the base of the fastener having an adhesive layer. The disadvantage of this technical solution is the labor-intensive installation of the extinguishing cord, associated with the need to install the proposed means of attachment to the inner walls of the electrical enclosure along its perimeter, after which the fire extinguishing cord is fixed in the mount.

A Self-Activating Fire Extinguishing Device is known (Patent RU 184841), which contains an enclosure made of foam plastic, inside which an explosive device and a fire extinguishing substance are placed. The explosive device is connected to a fire cord extending outwardly through an opening in the enclosure and placed in a closed recess made on the outside of the enclosure along its perimeter, the width of the recess being greater than the width of the fire cord. Grooves are made on the inside of the enclosure to facilitate its rupture when an explosive device is triggered. This device is suspended on a bracket or placed on a flat surface and self-activates when the flame touches the fire cord. The disadvantage of this technical solution is that the fire extinguishing device is placed in the protected room with electrical equipment with the help of a bracket or installed on a flat surface, which limits the variants of its location and leads to a decrease in the effectiveness of fire extinguishing.

An automatic fire fighting system for telecommunication equipment placed in a standard closed Telecommunication Rack (TCR) is known (Patent RU 190222). The device is a single structure containing an enclosure which houses a Flame-Extinguishing Agent Generator (FEAG) consisting of two tanks, which are connected to a system for delivering the flame-extinguishing agent to the fire source, consisting of pipelines and nozzles of the FEAG. The device initiation node is made in the form of an external line-extended sensor, which is routed through the most heat-loaded zones of the TCR and connected to the device input, which, in turn, is connected inside the device to a temperature threshold exceeding sensor. Additionally, the present device includes an actuation signaling device, which is a light and sound indicator indicating that the generator has produced a flame-retardant agent. This automatic fire extinguishing device offers standard flame-extinguishing agents, characterized by insufficient fire-extinguishing ability and with an unsafe chemical composition, which reduces the effectiveness of extinguishing; the presence of pipelines and nozzles for the supply of flame-extinguishing agent in the protected room increases the labor intensity of manufacturing the device; and the installation of the device in other types of premises with electrical equipment is characterized by an increased labor intensity due to the use of standard methods of attachment to the TCR.

An Automatic Firefighting System with fixation on DIN-rail (Patent RU 204767) is also known, consisting of an enclosure inside which the Generator of Fire Extinguishing Aerosol (GFEA) with the initiation unit is placed; the GFEA is made in the form of an enclosure made of fire-resistant material with an exit nozzle, in which Aerosol-Forming or Gas-Forming Composition (AFC) is placed, and in the AFS enclosure there are nozzle holes for the output of Aerosol-Forming or Gas-Forming Composition and a slot for fastening the enclosure with the GFEA on a DIN-rail, and the initiation unit is made in the form of a self-igniting fire cord. In the preferred embodiment, the initiation unit is made in the form of a self-igniting fire cord with a thermosensitive element, the activation temperature of which is less than the activation temperature of the fire cord. The disadvantage in this device is that the device presented in the patent is designed to be mounted on a DIN rail and, based on its size, it is impossible to mount it in a pattress box or the socket mounting area.

An autonomous fire extinguishing unit is known that is based on thermoactivated agent contained in microcapsules (Patent RU 179466), made in the form of a polymer composite plate with a regular surface relief and containing microcapsules with fire extinguishing agent placed in a special silicon-organic compound. The substrate of the plate has a heat-resistant self-adhesive layer on the reverse side to secure it in the protected volume. The design uses microcapsules of 50-400 microns in size as a fire extinguishing substance (agent); these microcapsules have a nucleus of fire-extinguishing liquid from a number of ozone-safe liquids placed inside a spherical polymer shell (Patent RU 2469761). Microcapsules are capable of explosion-like destruction when the temperature reaches 90° C. This fire extinguishing unit differs from the others in that it is necessary to glue a plate into the protected volume, which is an additional element; it requires additional installation work and leads to an inability to use aerosol-forming or gas-forming compositions and their mixtures, which reduces the effectiveness of extinguishing and is a significant disadvantage.

This technical solution is the closest analog to the claimed group of inventions and can act as a prototype.

### DISCLOSURE OF INVENTION

The technical problem, which the claimed solutions are aimed at solving, is the expansion of functional capabilities of junction boxes.

The technical result of the claimed inventions is to provide the possibility of complete suppression of fire inside the Electric Junction Box without the use of third-party extinguishing agents.

The specified technical result is achieved in the Anti-Fire Electric Junction Box, which is a pattress box containing a polymeric enclosure with internal protrusions that form a cavity in which the Fire Extinguishing Agent (FEA) is placed, made with the ability to exit into the protected volume of the enclosure and consisting of Aerosol-Forming Composition (AFC) or a mixture of AFC and Microencapsulated Agent.

An additional feature is that a heat triggering composition is applied to the FEA, with an initiation temperature lower than the initiation temperature of the FEA.

The specified technical result is also achieved in the Anti-Fire Electric Junction Box, which is a pattress box and contains a polymeric enclosure inside which a fire cord is placed that is filled with Fire Extinguishing Agent (FEA), made with the ability to exit into the protected volume of the enclosure and consisting of Aerosol-Forming Composition (AFC) or a mixture of AFC and Microencapsulated Agent.

An additional feature is that a heat triggering composition is applied to the FEA, having an initiation temperature lower than the initiation temperature of the FEA.

The proposed device is an assembly unit made in a single enclosure and has functional and constructive unity, so it can be claimed as a patent.

The possibility of installation of the proposed FEA-including device allows to suppress fire sources in the places of installation of junction boxes in limited spaces with high extinguishing ability.

Taking into account the fact that FEA consisting of AFC, when compared to powder, carbon dioxide and foam compositions, has no application restrictions (in terms of power of the protected electrical equipment or live voltage) and does not have a negative impact on electrical equipment, the proposed device can be installed in any place of Electric Junction Boxes installation, including in specialized recesses.

The use of the Electric Junction Box enclosure with the FEA placed in it makes it possible to mount or install the Electric Junction Box without additional fastening in any type of recesses, which reduces the labor intensity of installation. A properly installed extinguishing agent also has a maximum application efficiency, as the location, direction of the extinguishing agent release, and extinguishing parameters are calculated during the design of the device.

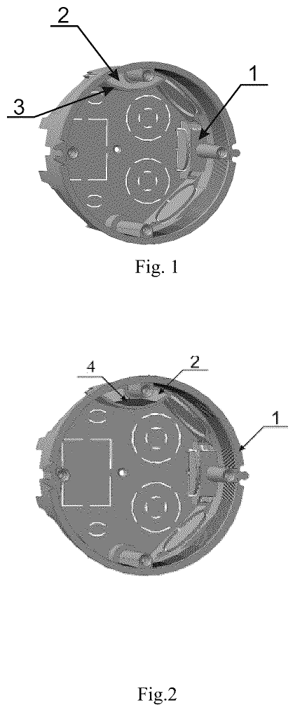

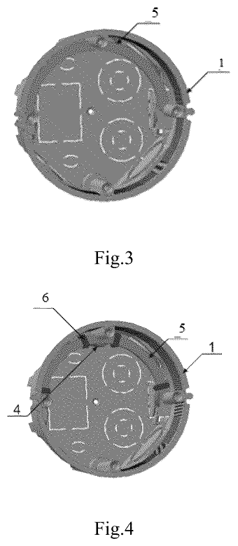

The claimed group of inventions is explained in the graphical materials, wherein FIG. 1 is the External view of the claimed device according to embodiment 1, FIG. 1. 2 is the External view of the claimed device according to embodiment 1 with heat trigger, FIG. 3 is the External view of the claimed device according to embodiment 2, FIG. 4 is the External view of the claimed device according to embodiment 2 with heat trigger.

### EMBODIMENT OF INVENTION

According to the first embodiment of the Electric Junction Box, hereinafter disclosed is an advantageous embodiment of the device, not intended to limit the scope of the protection claimed, as defined by the features of the independent claim.

In order to more fully understand the nature of the patent, the description makes reference to the explanatory figure (FIG. 1) according to which an external view of the device is presented.

In (FIG. 1) a view of the proposed Electric Junction Box (example of embodiment) is presented, where 1 is the enclosure of the Electric Junction Box, 2 is the FEA, and 3 is the protrusion for attaching the FEA.

The Electric Junction Box contains a Fire Extinguishing Agent (FEA) (2) which is an Aerosol-Forming Composition (AFC). The FEA (2) is placed in the enclosure of the Electric Junction Box (1), on the cavity formed by the protrusions inside the box. When the temperature rises to a critical level, e.g., 190° C., the FEA (2) begins to generate fire extinguishing aerosol and phlegmatizing agents in the gas phase into the protected volume at a high rate to create a high concentration of fire extinguishing aerosol inside the protected volume. Creating a high velocity extinguishing concentration of extinguishing agents in the protected volume is essential for suppressing developing fires. Alternatively, it is possible to apply a heat triggering composition to the FEA.

The peculiarity of using an Aerosol-Forming Composition (AFC) containing combustion inhibitors in the gas phase is that when initiating the AFC, the reaction of fire extinguishing aerosol generation starts, and the protected volume is always guaranteed to be filled with the maximum amount of fire extinguishing aerosol, calculated during the production of the device, which makes it possible to exceed the minimum required concentration for guaranteed fire suppression by several times. In the case of applying only microencapsulated composition containing combustion inhibitors in the gas phase, it is not uncommon to create a balance between the heat released from the source of ignition and the amount of generated combustion inhibitors released during the heating of microencapsulated composition, which leads to a temporary reduction in the intensity of combustion and eventually the re-development of the fire. Such an effect occurs because the principle of operation of microencapsulated compositions is based on the method of destruction of protective shells from the released heat of the ignition source.

In its original working condition, the Electric Junction Box is mounted in a recess. In the event of a fire, FEA (2) is triggered by the generated heat, for example, when the temperature reaches 190° C. During the operation of an FEA (2), extinguishing aerosol and phlegmatizing agents in the gas phase are released into the protected volume.

According to the second embodiment of the Electric Junction Box, further details are provided of the preferred embodiment of the device, not intended to limit the scope of the protection claimed, as defined by the features of the independent claim.

In order to more fully understand the nature of the patent, the description refers to the explanatory figure (FIG. 3) according to which an external view of the device according to embodiment 2 is presented.

In (FIG. 3) a view of the proposed Electric Junction Box (example of embodiment) is presented, where 1 is the enclosure of the Electric Junction Box, 4 is the heat trigger, 5 is the fire cord with FEA, 6 is the latches.

The Electric Junction Box contains a Fire Extinguishing Agent (FEA) (2), which is an Aerosol-Forming Composition (AFC). FEA (2) is placed inside the fire cord (5), within the box (1). The fire cord may be attached to the enclosure by adhesive or by latches along the entire length of the fire cord. When the temperature rises to a critical level, e.g. 190° C., the FEA (2) begins to generate fire extinguishing aerosol and phlegmatizing agents in the gas phase into the protected volume at a high rate to create a high concentration of fire extinguishing aerosol inside the protected volume. In addition, in an alternative embodiment, it is possible to apply a heat trigger to the fire cord. The heat trigger is applied at the beginning, end and middle parts of the fire cord. Creating a high velocity extinguishing concentration of extinguishing agents in the protected volume is essential for suppressing developing fires.

The peculiarity of using an Aerosol-Forming Composition (AFC) or its mixture with a microencapsulated composition containing combustion inhibitors in the gas phase is that when initiating the AFC, the reaction of fire extinguishing aerosol generation starts, and the protected volume is always guaranteed to be filled with the maximum amount of fire extinguishing aerosol, calculated during the production of the device, which makes it possible to exceed the minimum required concentration for guaranteed fire suppression by several times. In the case of applying only the microencapsulated composition containing combustion inhibitors in the gas phase, it is not uncommon to create a balance between the heat released from the source of ignition and the amount of generated combustion inhibitors released during the heating of microencapsulated composition, which leads to a temporary reduction in the intensity of combustion and eventually the re-development of the fire. Such an effect occurs because the principle of operation of microencapsulated compositions is based on the method of destruction of protective shells from the released heat of the ignition source.

The AFC composition consists of a dry solid mixture that generates combustion inhibitors during combustion, including sodium and/or potassium chlorides in the condensed phase (solid particles), combustion phlegmatizers in the gas phase, including nitrogen and carbon dioxide. Also, nitrogen and carbon dioxide act as oxygen insulators (inert gases).

The extinguishing principle consists in the complex use of both combustion inhibition functions and significant cooling of the fire source with the help of inert gases (nitrogen and carbon dioxide), which leads to slowing down the combustion reaction (phlegmatization) and isolation of the fire source from oxygen supply. In case of using a mixture of AFC and microencapsulated composition, to the combustion inhibitors, e.g. in the form of potassium and/or sodium chlorides, highly effective combustion inhibitors in the gas phase (gases) sealed in microcapsules and released during heating (combustion of the main AFC composition) are added. Such substances can be, for example, Freons, which significantly increases the extinguishing power of the mixture. It should be noted that microcapsules are collapsible shells in which the gas is sealed.

A heat triggering composition, having an initiation temperature lower than the initiation temperature of AFC, is a dry mixture of substances, one of which (or more) has a reduced auto-ignition temperature (e.g., ferrocene with an auto-ignition temperature of 175° C.-185° C.), and, at least, one more substance is an oxidizing agent, e.g., potassium chlorate. To be able to apply the composition and fix it on the surface, a fuel-binder, e.g. polyvinyl butyral in the form of a solution, must be added to the mixture.

After application and drying of the composition, the obtained mixture becomes highly sensitive to heating at temperatures in the range of 175° C.-185° C., which makes it possible to initiate the main composition of AFC or AFC+microcapsules at lower temperatures.

In its original working condition, the Electric Junction Box is mounted in a recess. In the event of a fire, the FEA (2) is triggered by the generated heat, e.g. when the temperature reaches 190° C. During the operation of an FEA (2), extinguishing aerosol and phlegmatizing agents in the gas phase are released into the protected volume.

1. An Anti-Fire Electric Junction Box, which is a pattress box that contains a polymeric enclosure with internal protrusions forming a cavity in which a Fire Extinguishing Agent (FEA) is placed, made with the ability to exit into the protected volume of the enclosure, and consisting of an Aerosol-Forming Composition (AFC) or a mixture of AFC and microencapsulated agent.

2. The box according to claim 1, characterized in that a heat triggering composition is applied to the FEA, having an initiation temperature lower than the initiation temperature of the FEA.

3. An Anti-Fire Electric Junction Box, which is a pattress box that contains a polymeric enclosure inside which a fire cord is placed, filled with a Fire Extinguishing Substance (FEA), made with the ability to exit into the protected volume of the enclosure, and consisting of an aerosol-forming composition (AFC) or a mixture of AFC and a Microencapsulated Agent.

4. The box according to claim 3, characterized in that a heat triggering composition is applied to the FEA, having an initiation temperature lower than the initiation temperature of the FEA.
